(19) United States
(12) Patent Application Publication
(10) Pub. No.: US 2011/0076940 A1
(43) Pub. Date: Mar. 31, 2011

(54) Underwater wireless communications hotspot

(76) Inventors: Mark Rhodes, West Lothian (GB); Brendan Hyland, Edinburgh (GB)

(21) Appl. No.: 12/567,497

(22) Filed: Sep. 25, 2009

(51) Int. Cl. H04B 13/02; H04B 5/00; H01Q 1/34

(52) U.S. Cl. 455/40; 343/709; 455/41.1

(57) ABSTRACT

The present invention provides an underwater wireless communications hotspot comprising an active zone which is circumscribed by a large closed loop antenna and within which wireless communication by means of electromagnetic signals can take place. The wireless communications hotspot of the present invention is suitable for data transfer between a communications node of the wireless hotspot and a receiver mounted on a mobile unit which is located inside the active zone of the hotspot. The wireless hotspot of the present invention provides a means for high bit rate data transfer from the communications node and the mobile unit, due to improved uniformity of coverage within the active zone of the hotspot and due to a reduction in the attenuation with distance compared to communications at positions outside the perimeter of a loop antenna.

### FIELD OF USE

The present invention relates generally to the field of underwater wireless communications, and specifically to the provision of an underwater wireless hotspot or zone in which wireless communication by means of electromagnetic signaling can take place.

### BACKGROUND OF THE INVENTION

Several improvements and technological advances have been made in the area of wireless telecommunications using electromagnetic signals over the last few decades. New products have been developed for commercial and industrial use exploiting various aspects of the electromagnetic spectrum to provide faster, more reliable communications at all levels. However, the recent technological advances apply almost exclusively to wireless communications in air. The field of underwater wireless communications has seen little development over the same timescale. Even today, the majority of underwater communications systems are still based on wired links.

There are a limited range of wireless systems based on the propagation of mechanical waves, in the form of sonar, or acoustic signaling. U.S. Pat. No. 6,130,859, “Method and Apparatus for Carrying out High Data Rate and Voice Underwater Communication”, Sonnenschein et al. describes a system for underwater communications based on the transmission and reception of acoustic waves. Sonnenschein describes a system where electrical signals are converted to mechanical signals for underwater transmission and vice versa using hydrophones. Communications systems based on the propagation of acoustic or mechanical waves, such as those taught in Sonnenschein suffer from a range of drawbacks. These drawbacks include distortion due to multi-path effects, echoes, Doppler effects, the long time delay between source and receiver, and the lack of a means to discriminate between signals which are produced by several sources.

One section of the electromagnetic spectrum—the visible spectrum—has some limited applications for underwater wireless communications. U.S. Pat. No. 5,894,450, “Mobile Underwater Arrays” Schmidt et al describes an underwater network array making use of both acoustic communications and the visible region of the electromagnetic spectrum for optical communications underwater. The visible region of the electromagnetic spectrum can be used for short range underwater communications. However, medium or long range communications are not possible in regions with significant turbidity—a high density of particles within the water. Turbidity rapidly degrades a signal in the visible spectrum as it propagates through water.

Radio signaling is the preferred means for wireless communications for many reasons. Radio signals can be produced by a transmitter using well established radio circuitry and design. Radio signals can be divided into multiple channels, and data modulated onto each channel separately. A vast range of protocols are available for the processing of data sent by radio waves, radio transmitters are efficient, do not produce unwanted effects the way acoustic waves or even visible radiation does.

Unfortunately, radio waves are severely affected by the high conductivity of water (especially sea water) which produces a very high level of attenuation with distance for a radio signal underwater. This effect limits the use of radio signaling for underwater communications to short range low bandwidth communications.

GB Patent Application No 8420017, “Inductive Communications System” Raynor, describes a method for underwater communications within a short range by exciting the magnetic component of an electromagnetic signal. However, the inductive communications system taught in Raynor is not suitable for the provision of an underwater wireless hotspot or zones due to the rapid fall off with range of inductive communications, due to the limitation of inductive communications systems to well inside the near-field, and consequently due to the low frequency of operation and correspondingly low bandwidth of data transfer.

Magnetic and electromagnetic signals are attenuated as they pass through a conductive medium and attenuation increases with frequency. For this reason the inductive communications system taught in Raynor is implemented using low carrier frequencies presenting limitations for channel capacity.

### SUMMARY OF THE INVENTION

An improved transmission arrangement for underwater wireless communications would allow use of a higher carrier frequency. The provision of an underwater wireless hotspot or zone within which data transfer between two transceiver devices could occur at high bit rates based on the propagation of electromagnetic signals would be a highly beneficial development. For example, such a system would facilitate an underwater mobile unit comprising a receiver to upload data from an underwater communications node once the receiver was located within the hotspot. Compared to systems based on wired communications or acoustic and/or optical communications this system would provide several advantages. In particular, this system would eliminate the need for precise determination of the location of the underwater node by increasing the area over which high bandwidth communications are provided. It should be noted that underwater position determination by pre-programming of co-ordinates has a limited resolution, and position determination systems based on the use of homing devices also have several drawbacks. Other benefits of the an underwater wireless hotspot would be the elimination of cables and underwater connectors, the elimination of the need for precise positioning and alignment of optical transmitters/receptors; moreover the system would be insensitive to the local environment so that turbidity or reflections from hard objects (which are known to degrade acoustic signals) would not cause problems. Such a system would further allow coding of signals so that multiple data channels could be downloaded simultaneously.

Accordingly, it is an object of the present invention is to provide an underwater wireless communications hotspot. The underwater wireless communications hotspot of the present invention facilitates high data rate communications between an underwater station, such as an underwater data monitoring station, and a receiver mounted on a mobile unit, such as an Autonomous Underwater Vehicle (AUV), or a Remotely Operated Vehicle (ROV). Communications between the underwater station and the mobile unit occurs within a defined communications area, volume or zone. The underwater station includes a communications node which can transmit a data stream to the receiver, and may include one or more sensors for measuring the properties of the sea or the sea bed. Alternatively, the underwater station may include one or more sensors for monitoring the conditions of an underwater pipeline, an underwater drilling assembly or any underwater installation.

The communications node of the wireless communications hotspot of the present invention comprises a transmitter for transmitting electrical signals to a closed loop antenna. The perimeter of the underwater wireless communications zone is described by the closed loop antenna. Communications between the communications node and the underwater vehicle is by means of magnetic signals induced by the closed loop antenna inside the communications area, volume or zone.

The underwater wireless communications hotspot of the present invention provides a higher density of RF power for signals received within the active zone providing improved efficiency for a given level of RF power compared with an alternative system based on a pair of spatially separated antennas and hence enables transmission of higher bandwidth signals with greater data capacity.

Preferably the communications zone is located on the seabed; similarly, the closed loop antenna is preferably located on the seabed. Optionally the closed loop may be embedded in the seabed.

In one embodiment of the present invention, data can be transferred from the communications node and the underwater vehicle after a handshaking signal is transmitted by the amphibious vehicle. The handshaking signal may be received by the communications node via the closed loop antenna, or by means of a separate receiving antenna of the communications node. Similarly, the mobile unit, which includes the receiver, may include a transmitter for sending the handshaking signal.

In further embodiments two way wireless data communications can occur between the communications node and the underwater vehicle comprising a downlink signal from the underwater vehicle to the communications node and an uplink signal from the communications node to the underwater vehicle.

The magnetic signals which are induced by the closed loop antenna of the present invention are preferably modulated on radio carrier signals with frequencies in the range from 10 Hz to 10 MHz

Preferably, the magnetic signals which are induced by the closed loop antenna are in the very low frequency (VLF) range or the ultra low frequency (ULF) range.

The underwater wireless communications hotspot of the present invention is capable of supporting data transfer rates of up to 10 mega bits per second.

Preferably the closed loop antenna of the present invention is formed into one of the following geometric shapes: a circular, an oval, a rectangle; alternatively the closed loop antenna may be formed into the shape of an irregular polygon. Further alternatively, the closed loop antenna of the present invention may be formed into a loop which includes at least one point where the loop crosses over itself thereby forming at least two non-intersecting closed areas.

A second object of the present invention is to provide an underwater wireless communications hotspot wherein the variation of the magnetic field strength of magnetic signals induced by the closed loop antenna inside the communications zone are within a defined range at a given moment in time. In this way, the underwater wireless communications hotspot of the present invention provides a high level of uniformity of coverage within the communications area, volume or zone.

Preferably the variation of the magnetic field strength of magnetic signals inside the communications zone at a given moment in time is within −10 dB of the peak value within the communications zone.

In further embodiments, a pair of closed loop antennas are provided, and are arranged so that both antennas lie substantially in co-axial alignment, i.e. so that each of the pair of closed loop antennas shares the same centre perpendicular axis but where there is an offset distance between the pair of antennas. The pair of closed loop antennas, thus arranged, defines a cylindrical volume which is sandwiched between each of the pair of closed loop antennas. In use, the antennas are connected in parallel so that electrical signals which are fed from the transmitter of the communications node are applied equally to both of the pair of closed loop antennas. The offset distance may be selected so that the pair of closed loop antennas forms a pair of Helmholtz coils. In this case, the variation of the magnetic field strength of magnetic signals inside the volume between the pair of antennas at a given moment in time is minimized.

A communications zone offering a reduced or minimized variation of the magnetic field strength of magnetic signals induced inside the communications zone has the advantage that complex power adjustment routines are not required to maintain connectivity over the full area or volume of the zone. In addition, a zone offering a reduced or minimized signal strength over its entire area or volume does not suffer from drop-out within areas of poor signal strength.

### BRIEF DESCRIPTION OF DRAWINGS

FIG. 1 shows a drawing of an underwater wireless communications hotspot according to the present invention.

FIG. 2a shows a circular wire loop antenna which may be used in the underwater wireless communications hotspot of FIG. 1.

FIG. 2b shows how the two currents in opposite sides of a circular wire loop interfere constructively producing a substantially constant field within the loop and interfere destructively outside the loop to produce a rapidly decaying magnetic field strength.

FIG. 3 shows a plot of the magnetic field strength profile produced by a current flowing in the circular wire loop of FIG. 2a. The horizontal axis of the plot of FIG. 2b corresponding to a line which bisects the centre of the loop.

FIG. 4 shows the normalized variation in magnetic field strength with distance from an ideal magnetic dipole antenna

FIG. 5 shows a block diagram of a wireless communications node according to the present invention.

FIG. 6 shows a block diagram of a receiver used to receive signals in the underwater wireless communications hotspot of the present invention.

FIG. 7 shows a drawing of an underwater wireless communications hotspot according to a second embodiment of the present invention.

### DETAILED DESCRIPTION

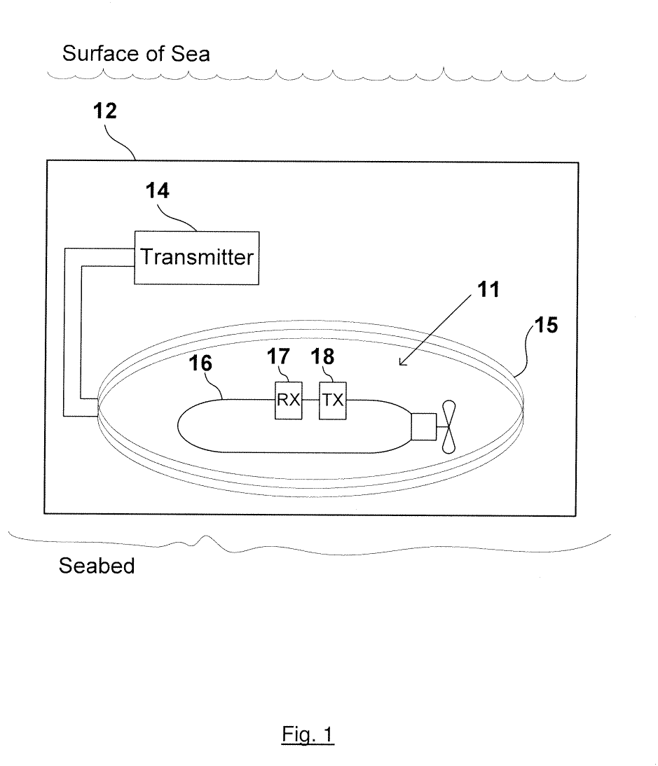

FIG. 1 shows a drawing of an underwater wireless communications hotspot according to a first embodiment of the present invention. The underwater wireless communications hotspot of FIG. 1 comprises an active zone 11, a communications node 12 comprising a transmitter 14, connected to a closed loop antenna 15 which is wound from several turns of insulated electrically conducting wire. The active zone of the underwater wireless communications hotspot 11 of FIG. 1 is circumscribed by closed loop antenna 15. A mobile unit 16, comprising a built in receiver 17 is positioned within the active zone 11. Receiver 17, receives the magnetic signals transmitted inside loop antenna 15 of communications node 12 of FIG. 1. Mobile unit 16 further comprises a transmitter 18 which can transmit a handshaking signal to be received by communications node 12 so as to activate a process of data transfer between communications node 12 and mobile unit 16. Wire loop antenna 15 typically encloses a large area, in the order of tens of square metres, thereby providing an underwater wireless communications hotspot that is sufficiently large for non-critical positioning of mobile unit 16.

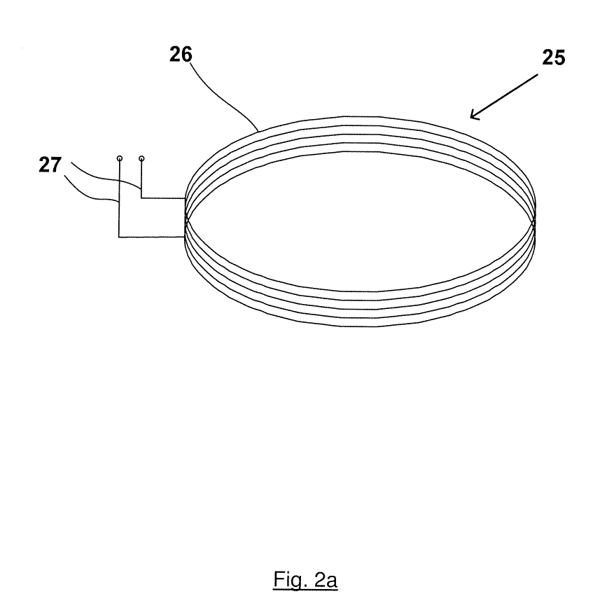

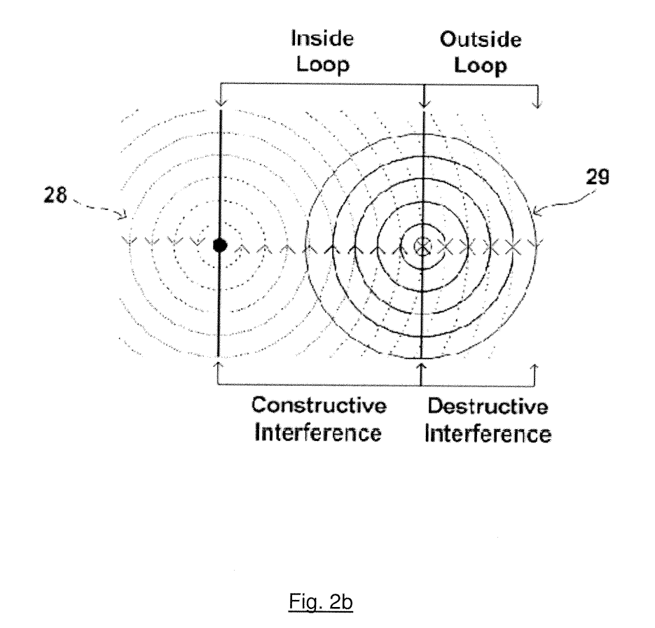

FIG. 2a shows a circular wire loop antenna 25 which may be used in the underwater wireless communications hotspot of FIG. 1. The antenna of FIG. 2a comprises a number of turns of wire 26, formed into a circular loop, and so that a pair of ends of the wire 27 protrude for connection to the transmitter 14 of FIG. 1. FIG. 2b shows a cross section of the antenna of FIG. 2a and illustrates how the opposing currents 30 and 31 on opposite sides of the loop produce a pair of magnetic fields 28, 29 giving rise to constructive interference inside the loop and destructive interference outside the loop. The constructive interference between the fields generated by the opposing sides of the loop produces a strong magnetic field inside the loop, with limited variation of the magnetic field strength; at the same time, the destructive interference between the fields generated by the opposing sides of the loop produces a weaker magnetic field outside the loop, that falls off rapidly with distance from the centre of the loop. FIG. 2b illustrates a benefit of the underwater wireless communications hotspot of FIG. 1 of the present invention comprising a transmitter 14, connected to a closed loop antenna 15 defining an active zone 11 and with a receiver located inside the transmit loop compared to an alternative system for communicating with a receiver at a distance outside the transmitting loop. While both systems suffer from conductive attenuation of the magnetic signals, the system of the present invention which places the receiver inside the transmit loop benefits from constructive addition of the magnetic fields produced by current elements at opposite sides of the loop.

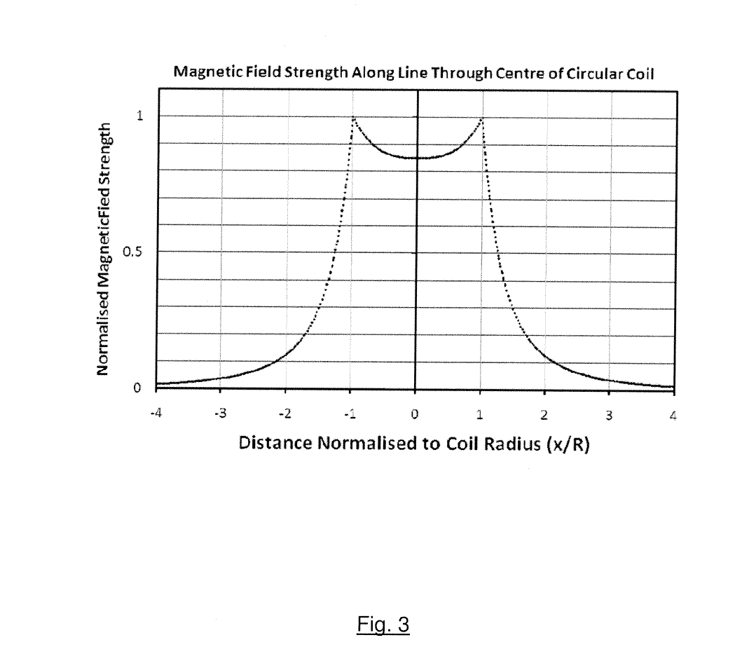

FIG. 3 shows a plot of magnetic field strength produced by a current in a circular loop formed of an electrically conductive material such as the closed loop antenna 15 of FIG. 1. The plot of FIG. 3 is taken along a line which passes through the centre of the circular loop. The vertical axis of plot is normalized to a value of unity; similarly, the horizontal axis of the plot is normalized to units of the loop radius. It can be seen from the plot of FIG. 3 that the magnetic field strength varies only slightly within the loop and falls off very rapidly once outside the loop. The rapid fall off in the magnetic field strength outside the perimeter of the closed loop is due to an inverse cubed dependence of the field outside the loop.

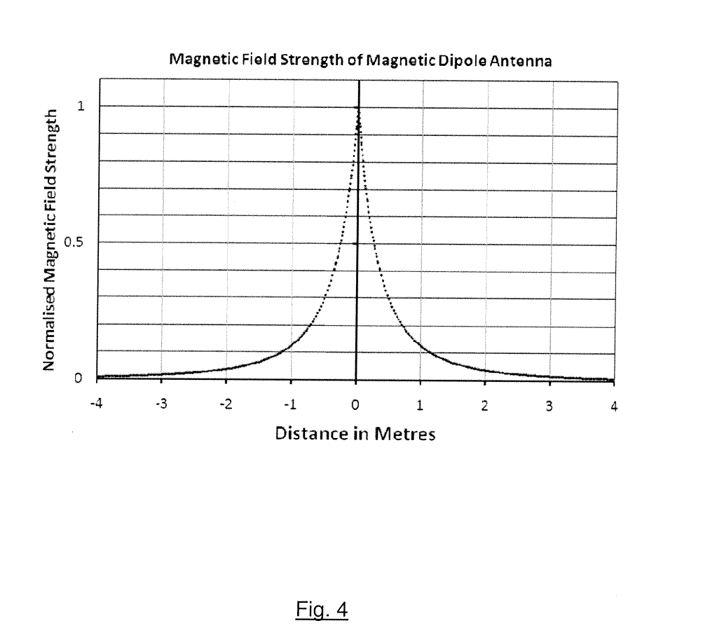

FIG. 4 shows a plot of the magnetic field strength produced by a magnetic dipole antenna. The magnetic field intensity falls off according to an inverse cubed relationship with distance from the antenna source (1/r³). The plot of FIG. 4 highlights the problems that would occur if an attempt was made to establish an underwater wireless hotspot using a system comprising a magnetic dipole antenna. The rapid variation in magnetic field strength over the entire area of the hotspot would present difficulties in maintaining connectivity over the full area of the hotspot; moreover, the exact boundaries of the hotspot would not be well defined. A further problem would arise from the need to use very low frequency electrical signals in order to extend the useable range over a few metres from the antenna. This restriction would bring an undesirable limitation on bandwidth, since the bandwidth of an electrical signal is in the same order as the channel width, and since the channel width necessarily decreases as the carrier frequency is reduced.

By contrast the underwater wireless communications hotspot of the present invention is capable of providing a large active zone covering tens of square metres, where the received signals within the active zone do not substantially fall-off or drop out at varying locations inside the active zone. Compared to an underwater wireless communications hotspot based on one or more dipole antennas, the underwater wireless communications hotspot of the present invention provides an active zone of a larger area, a higher power density of received signals, and can operate at higher frequencies providing a higher bandwidth for high bit rate data transfer.

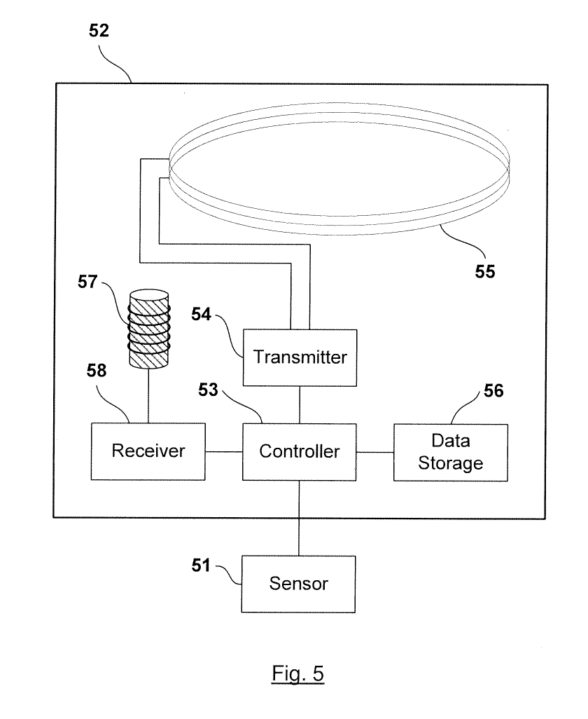

FIG. 5 shows a block diagram of the integral components of the communications node 52 of the underwater wireless communications hotspot of FIG. 1 separately comprising transmitter 54 and loop antenna 55 and connected to a sensor 51 for measuring data. Sensor 51 may be a pressure sensor, a vibration sensor, a sensor for measuring electrical conductivity or resistance, an optical sensor for measuring optical properties such as opacity, or any type of sensor which is used to monitor local environment or to monitor the condition of an underwater installation. Sensor 51 is connected to controller 53. Controller 53 comprises programmable integrated circuits and other electronic devices (not shown) as required and as would be known to a person skilled in the art of system design. Measured data from sensor 51 is stored in data storage device 56 which is also connected to controller 53. An output from controller 53 is connected to an input of transmitter 54. Communications node 52 further comprises a solenoid antenna 57, which is connected to a receiver 58. Receiver 58 is provided to receive a handshaking signal incident on solenoid antenna 57. An output from receiver 58 is connected to controller 53, which receives the handshaking signal. When a handshaking signal is received by controller 53, a sequence for downloading the data stored in data storage device 56 is commenced. Transmitter 54 comprises programmable integrated circuits and other electronic devices (not shown) as required to modulate the data stream onto a carrier signal according to a pre-defined modulation scheme. An output from transmitter 54 is connected to loop antenna 55, so that the electrical signal fed from the output of transmitter 54 is converted to a magnetic signal which can be received within the perimeter of the closed loop antenna 55.

While the high attenuation of an electromagnetic signal underwater is typically considered to be a disadvantage, for underwater wireless communications hotspot according to the present invention the high fall off of the signal provides the following two surprising benefits: the first is that the boundary of the wireless communications zone is well defined, so that there is no ambiguity regarding the correct positioning of the mobile unit to receive the data stream from the communications node; the second benefit is that a plurality of wireless communications zones can be provided in close proximity, without any danger of interference. This benefit permits the full available bandwidth of the transmitted signal to be utilized to provide a high bandwidth for data transfer. It can be seen from FIG. 3 that a pair of circular antennas placed with centre to centre separation of 4 times the radius (one diameter between each antenna) would be sufficiently well isolated so that interference is not an issue. Thus the present invention provides a means for wireless transfer from a plurality communications nodes, for example connected to a plurality of data collection sensor stations which are closely spaced. Each communications node can operate using the same protocol on an open channel, so that pre-programming or pre-multiplexing of the transmitters of each communications node is not necessary.

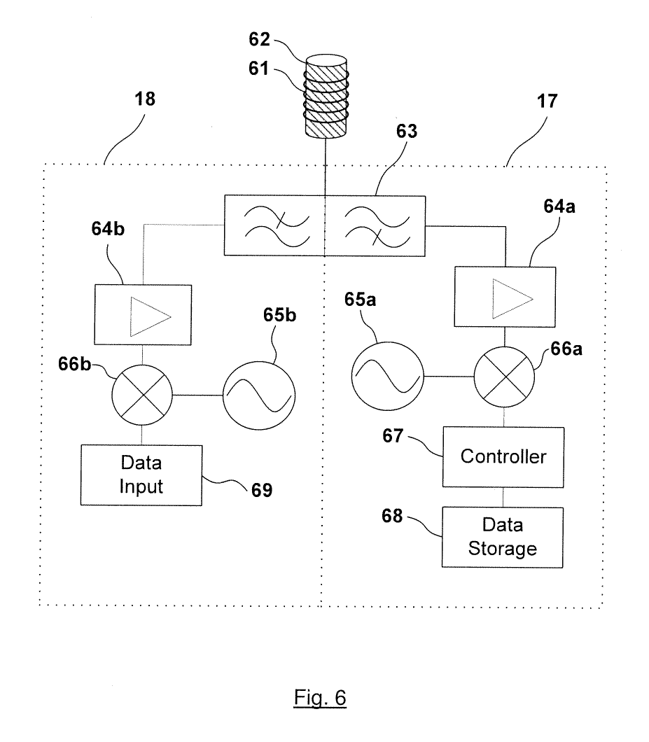

FIG. 6 shows a block diagram of the integral components of receiver 17 and transmitter 18 which are integrated in mobile unit 16 of the underwater wireless communications hotspot FIG. 1. Receiver 17 and transmitter 18 share a common solenoid antenna 61 wound on a core 62 formed of a material having a high relative permeability such as ferrite. Solenoid antenna 61 has a very high sensitivity to magnetic signals and hence is suitable to receive the magnetic signal transmitted by closed loop antenna 15 of FIG. 1. Solenoid antenna 61 is connected to receiver 17 via one section of branching circuit 63. Receiver 17 comprises low noise amplifier (LNA) 64a, local oscillator 65a, mixer 66a, and controller 67. Controller 67 comprises programmable integrated circuits and other electronic devices (not shown) as required and as would be known to a person skilled in the art of system design. Data received by solenoid antenna 61 is fed to LNA 64a via branching circuit 63, and is demodulated by local oscillator 65a and mixer 66a and is passed to controller 67, which directs the data to a storage device 68 where it is stored to be accessed at some later stage. Receiver 17, receives the magnetic signals transmitted inside loop antenna 15 of communications node 12 of FIG. 1. Transmitter 18 is also connected to solenoid antenna 61 via branching circuit 63. Transmitter 18 includes power amplifier 64b, local oscillator 65b, mixer 66b and data input 69. Transmitter 18 can be used to send a downlink signal to communications node 12 of FIG. 1. The downlink signal is fed to solenoid antenna 61 via branching circuit 63. For many applications, there is no requirement that the downlink signal occupy a wide bandwidth; therefore, the downlink signal can be modulated on a low frequency carrier; in this way branching circuit 63 can be formed from a pair of filters, for example a low pass filter and a high pass filter, with a common node thereby isolating the transmitted downlink signal from the received data signal in the frequency domain.

In alternative embodiments, handshaking circuit 63 isolates the transmitted branching signal from the received data signal in the time domain by means of high frequency switching circuitry.

In further alternative embodiments, transmitter 64 is connected to a separate TX antenna (not shown) of mobile unit 16. This provides a further option for isolation of the two signals by means of the design and structure and separation of the TX antenna and solenoid antenna 61.

In further preferred embodiments two way wireless data communications can occur between the communications node and the underwater vehicle comprising a downlink signal from the underwater vehicle to the communications node and an uplink signal from the communications node to the underwater vehicle.

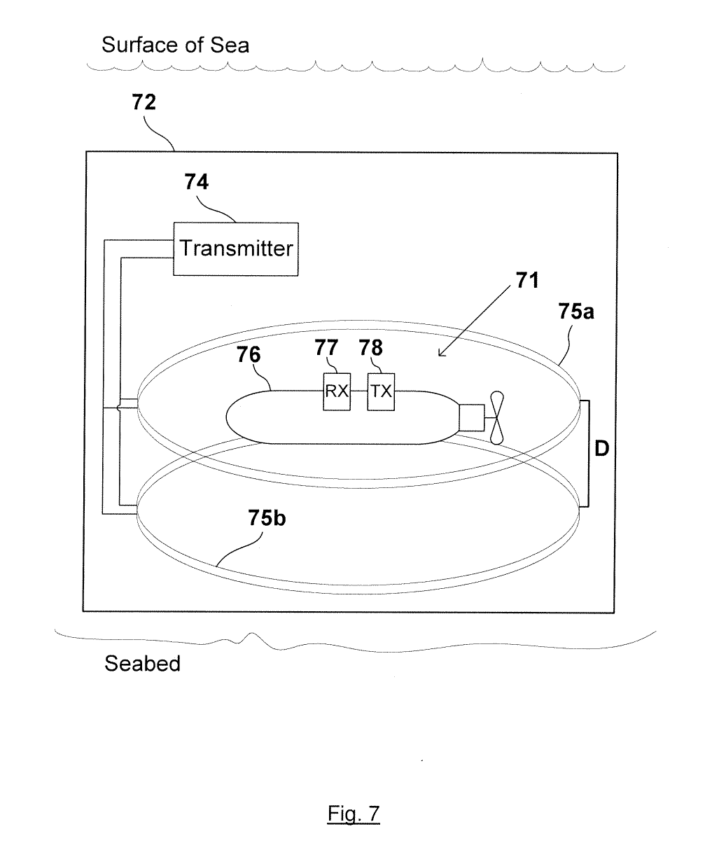

FIG. 7 shows a drawing of an underwater wireless communications hotspot according to a second embodiment of the present invention. The underwater wireless communications hotspot of FIG. 7 comprises an active volume 71, a communications node 72 comprising a transmitter 74, connected to a pair of circular loop antennas 75a, 75b each of which is wound from several turns of insulated electrically conducting wire. The pair of circular loop antennas 75a, 75b have the same shape, and are positioned so there is an offset distance D between each loop and so that that the same centre perpendicular axes is common to each of the pair of circular loop antennas. The active volume of the underwater wireless communications hotspot 71 of FIG. 7 is defined by the cylindrical region between the pair of circular loop antennas 75a, 75b. A mobile unit 76, comprising a built in transceiver 77 is positioned within the active volume 71. Mobile unit 76 further comprises a transmitter 78 which can transmit a handshaking signal to be received by communications node 72 so as to activate a process of transfer of data between communications node 72 and mobile unit 76. The offset distance D between the pair of loop antennas 75a and 75b is advantageously equal to the radius, which defines separation of a pair of Helmholtz coils.

The underwater wireless communications hotspot according to the embodiment of the present invention depicted in FIG. 7 is capable of providing a large active volume covering tens of cubic metres, within which variations in the received signal strength are minimized, and which can operate at higher frequencies providing a high bandwidth for high bit rate data transfer.

The systems and methods described herein are generally applicable to seawater, fresh water and any brackish composition in between. Since relatively pure fresh water environments exhibit different electromagnetic propagation properties from saline seawater, different operating conditions may be preferred in each environment. Any optimization required for specific saline constitutions will be obvious to a practitioner skilled in this area.

Moreover, the above descriptions of the specific embodiments is made by way of example only and not for the purposes of limitation. It will be obvious to a person skilled in the art that in order to achieve some or most of the advantages of the present invention, practical implementations may not necessarily be exactly as exemplified and can include variations within the scope of the present invention.

What is claimed is:

1. A subsea wireless hotspot, comprising a communications zone a communications node and a receiver,
said communications node comprising a transmitter and a first closed loop antenna connected to an output from said transmitter,
a perimeter of said communications zone being circumscribed by said first closed loop antenna,
wherein, during use, an electrical signal is passed from said output of said transmitter to said first closed loop antenna thereby producing an alternating magnetic field within said zone, and producing a corresponding magnetic signal within said zone,
whereby said receiver receives said magnetic signal when located inside said communications zone.

2. A subsea wireless hotspot according to claim 1 wherein said communications node is located on the seabed.

3. A subsea wireless hotspot according to claim 1 wherein said first closed loop antenna is located on the seabed.

4. A subsea wireless hotspot according to claim 1 wherein said first closed loop antenna is embedded the seabed.

5. A subsea wireless hotspot according to claim 1 wherein said receiver is mounted on a mobile unit.

6. A subsea wireless hotspot according to claim 5 wherein said communications node further comprises a receiver for receiving a downlink signal transmitted by said mobile unit.

7. A subsea wireless hotspot according to claim 6 wherein said downlink signal is received by said communications node via said first closed loop antenna.

8. A subsea wireless hotspot according to claim 6 wherein said downlink signal is a handshaking signal.

9. A subsea wireless hotspot according to claim 1 wherein the frequency of said alternating magnetic signal is in the range from 10 Hz to 10 MHz

10. A subsea wireless hotspot according to claim 1 wherein said magnetic signals are used for data transfer from said communications node to said receiver.

11. A subsea wireless hotspot according to claim 10 wherein the bit rate of said data transfer is in the range from 10 bps to 10 Mbps.

12. A subsea wireless hotspot according to claim 1 wherein said first closed loop antenna forms a circular loop.

13. A subsea wireless hotspot according to claim 1 wherein said closed loop antenna forms a rectangular loop.

14. A subsea wireless hotspot according to claim 1 wherein said closed loop antenna forms an irregular polygon.

15. A subsea wireless hotspot according to claim 1 wherein said first closed loop antenna comprises at least one crossover point so as to form at least two non-intersecting closed areas.

16. A subsea wireless hotspot according to claim 1 wherein said communications node is connected to a data collection device.

17. A subsea wireless hotspot according to claim 16 wherein said data collection device collects data relating to the physical condition of the seabed.

18. A subsea wireless hotspot according to claim 16 wherein said data collection device collects data relating to the physical state an underwater pipeline.

19. A subsea wireless hotspot according to claim 16 wherein said data collection device includes memory storage device.

20. A subsea wireless hotspot according to claim 1 wherein, at a given point in time, said magnetic signal is substantially uniform across said communications zone.

21. A subsea wireless hotspot according to claim 1 further comprising a second closed loop antenna, having the same shape as said first closed loop, said first and said second closed loop antenna lying substantially in co-axial alignment and being separated by an offset distance wherein said electrical signal is fed to said first and second closed loop antennas in parallel and wherein said communications zone is extended to include the volume between said first and said second closed loop antennas.

22. A subsea wireless hotspot according to claim 21 wherein said offset distance is equal to the loop radius.

23. A subsea wireless hotspot according to claim 21 wherein, at a given point in time, said magnetic signal is substantially uniform within said extended communications zone.
